(19) United States
(12) Patent Application Publication
(10) Pub. No.: US 2006/0273543 A1
(43) Pub. Date: Dec. 7, 2006

(54) Bicycle with a frame of tubes connected to each other so that they can pivot

(76) Inventors: Ronnie De Jong, HW Goirle (NL); Arie Oranje, MC Tilburg (NL)

Correspondence Address: LAW OFFICES OF ERIC KARICH, 2807 ST. MARK DR., MANSFIELD, TX, 76063, US

(21) Appl. No.: 11/436,066

(22) Filed: May 17, 2006

(30) Foreign Application Priority Data
Nov. 17, 2004 (WO) PCT/NL04/00804
Nov. 17, 2003 (NL) 1024797

(51) Int. Cl. B62K 17/00

(52) U.S. Cl. 280/278; 280/281.1

(57) ABSTRACT

A bicycle has a frame comprising a head tube, a bottom bracket tube, a top tube, and a down tube that are pivotally connected to form a four bar system. The bicycle further includes a saddle that is attached to a seat post and pivotally connected to the top tube. By tilting the bottom bracket tube downwards the head tube is also pulled downwards, and the bicycle is brought from a normal position to a recumbent position. Tilting the bottom bracket tube downwards takes place by exerting a force, for example the user's weight, on the saddle. This force is transmitted to the bottom bracket tube through an auxiliary connecting bar, which is pivotally connected to the seat post and the bottom bracket tube.

### CROSS-REFERENCE TO RELATED APPLICATIONS

This application for a utility patent claims the priority of International Application number PCT/NL2004/000804, having an international filing date of Nov. 17, 2004. This application also claims the priority of a foreign patent application in the Netherlands, having application number 1024797, and filed Nov. 17, 2003. These previous applications are hereby incorporated by reference in their entirety.

### STATEMENT REGARDING FEDERALLY SPONSORED RESEARCH

Not Applicable

### BACKGROUND OF THE INVENTION

1. Field of the Invention

The invention relates to a bicycle comprising a frame with a head tube, a top tube that is connected to the head tube, a down tube that is also connected to the head tube, and a bottom bracket tube that is connected to the top and down tubes, in which all the connecting points between the tubes are situated at a distance from each other, which bicycle, furthermore, comprises a bottom bracket spindle that is connected to the bottom bracket tube, as well as a handlebar stem that can rotate in the head tube, a handlebar that is attached to the handlebar stem, a fork that is connected to the handlebar stem, a front wheel that is attached to the fork so that it can revolve, and a rear wheel and a saddle that are connected to the frame.

2. Prior Art

Such a bicycle is generally known. In addition to the most common version of a normal bicycle, on which one sits upright, such a bicycle is also known in the form of a recumbent bicycle, on which one assumes a more recumbent position. Recumbent bicycles are still a rare sight on the street. This is because mounting and dismounting as well as standing still is more difficult with a recumbent bicycle than with a normal bicycle. Opposed to this disadvantage, is the advantage that a higher speed can easily be attained with recumbent bicycles, which is especially favourable in the country on long, straight roads. However, the difficulties in handling a recumbent bicycle in towns frighten most people off from using them.

### SUMMARY OF THE INVENTION

An objective of the invention is to provide a bicycle of the type described in the preamble that has the advantages of a normal bicycle as well as those of a recumbent bicycle, but without the disadvantages of a recumbent bicycle. To this end, the bicycle according to the invention is characterized in that the head tube, the bottom bracket tube and the down tube as well as the top tube are connected to each other so that they can pivot. By making the tubes of the frame so that they can pivot with respect to each other, the bicycle according to the invention can take on different forms varying from that of a normal bicycle to that of a recumbent bicycle. Because of this, the bicycle can be used as a normal bicycle, for example in towns, and as a recumbent bicycle, for example in the country.

In order for the bicycle to work well, it is desirable that the position of the fork does not change or only just slightly so while the position of the bicycle is being changed. In order to achieve this, again an embodiment is characterized in that the fork is connected to the handlebar stem so that it can rotate and is supported on bearings in an auxiliary element so that it can rotate, which element is connected to the head tube so that it can pivot, and that the bicycle, furthermore, comprises an auxiliary bar, which is connected to the down tube and to the auxiliary element so that it can pivot, in which all the pivoting points between the head tube, the down tube, the auxiliary element and the additional auxiliary bar are situated at a distance from each other. While changing the position of the bicycle from the normal position to the recumbent position, the head tube takes on a more horizontal position. The presence of the auxiliary element and the additional auxiliary bar prevents the position of the fork from changing along with that of the head tube and sees that the position of the fork does not change or only slightly so.

Another embodiment with which it is possible to attain that the position of the fork does not change or only slightly so while the position of the bicycle is being changed is characterized in that the fork is connected to the handlebar stem so that it can rotate and is supported on bearings in an auxiliary element so that it can rotate, which element is connected to the head tube so that it can pivot, and that the bicycle, furthermore, comprises an auxiliary bar, which is connected to the down tube and to the auxiliary element so that it can pivot, as well as an additional auxiliary bar, which is connected to the down tube and to the head tube so that it can pivot, in which all pivoting points between the head tube, the down tube, the auxiliary element and the first and the additional auxiliary bar are situated at a distance from each other.

In order to obtain both a good normal bicycle and a good recumbent bicycle in the two extreme positions, the distance between the connecting points on the head tube of the top and down tubes with the head tube is preferably greater than the distance between the connecting points of the top and down tubes with the bottom bracket tube. Furthermore, it is preferable that the distance between the connecting points on the down tube is smaller than the distance between the connecting points on the top tube.

A further embodiment of the bicycle according to the invention is characterized in that the bicycle, furthermore, comprises a seat post, to which the saddle is attached and that is connected to the top tube so that it can pivot, as well as an auxiliary connecting bar, which is connected to the seat post and the bottom bracket tube so that it can pivot. This construction makes it possible for the user to employ his own weight when changing the bicycle from a position corresponding to that of a normal bicycle to a position corresponding to that of a recumbent bicycle. The user's own weight on the saddle is transmitted through the seat post and the auxiliary connecting bar to the bottom bracket tube that, because of this, is pushed away as a result of which the tubes of the frame pivot with respect to each other.

An alternative for this embodiment is characterized in that the bicycle, furthermore, comprises a seat post, to which the saddle is attached and which is connected to the top tube so that it can pivot, as well as a belt or chain that passes over two belt wheels, one of which is attached to the seat post at the pivoting point between the top tube and the seat post, and the other belt wheel is attached to the bottom bracket tube at the connecting point between the top tube and the bottom bracket tube.

In order to have the change of position take place gradually and not all at once, in still another embodiment, the bicycle comprises a gas spring with a damping effect, which is connected to the seat post and the top tube so that it can pivot.

In order to prevent undesirable changes in the position of the bicycle from taking place, still a further embodiment is characterized in that the bicycle comprises an adjustable blocking mechanism, which can block any pivoting of the tubes of the frame.

The blocking mechanism preferably comprises the gas spring, in which the gas spring can be blocked. Being able to block the gas spring means that the piston can be secured against movement with respect to the piston housing. By blocking the gas spring, the frame's tubes cannot pivot with respect to each other. In this way an inexpensive blocking mechanism is obtained.

Still a further embodiment is characterized in that the handlebar stem comprises two parts that can slide with respect to each other, which are blocked against rotating with respect to each other, in which one part is connected to the fork so that it can rotate and the other part is attached to the handlebar. Because of this, the handlebar stem can be pulled out, as a result of which when the bicycle is in the recumbent position, in which the user's shoulders are further from the handlebar stem, the handlebar can be pulled closer to him.

In again a further embodiment, the bicycle comprises, furthermore, a back support, which consists of a left part and a right part, which parts can rotate between a first position in which they are situated in one plane, perpendicular to the frame, and a second position in which they are parallel to each other and to the frame. The back support is only used in the recumbent position. The back support has no function in the normal position and increases the air resistance. The air resistance is greatly reduced by swinging the back support down when the bicycle is in the normal position.

### BRIEF DESCRIPTION OF THE DRAWINGS

The invention will be elucidated more fully below on the basis of drawings in which embodiments of the bicycle according to the invention are shown. In these drawings:

FIG. 1 shows a first embodiment of the bicycle according to the invention in the normal position;

FIG. 2 shows the bicycle shown in FIG. 1 in the recumbent position;

FIG. 3 shows a second embodiment of the bicycle according to the invention in the normal position;

FIG. 4 shows the bicycle shown in FIG. 3 in the recumbent position;

FIG. 5 shows a detail of a third embodiment of the bicycle according to the invention; and

FIG. 6 shows a fourth embodiment of the bicycle according to the invention in the recumbent position.

### DETAILED DESCRIPTION OF THE DRAWINGS

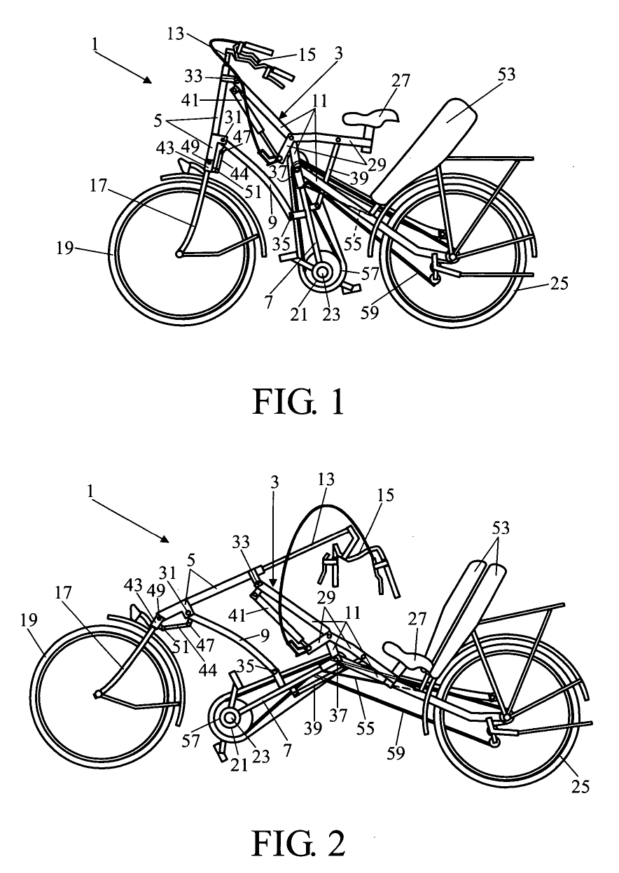

In FIG. 1 an embodiment of the bicycle according to the invention is shown. The bicycle 1 is in the normal position, that is, a position which corresponds to that of most common bicycles, in which the user sits practically upright on the bicycle. In FIG. 2, the bicycle 1 is shown in the recumbent position, that is, a position that corresponds to that of a recumbent bicycle, in which the user assumes more of a recumbent position than an upright position.

The bicycle 1 has a frame 3 comprising a head tube 5, a bottom bracket tube 7 as well as a down tube and a top tube 9, 11. The head tube 5 guides a handlebar stem 13 on one end of which a handlebar 15 is attached and of which the other end is connected to a fork 17 in which a front wheel 19 is supported on bearings. On the other end of the bottom bracket tube 7 there is a bottom bracket housing 21 in which a bottom bracket spindle 23 is supported on bearings. The top tube 11 is connected at one end to the head tube 5 so that it can pivot and near its middle it is connected to one end of the bottom bracket tube 7 so that it can pivot. A rear wheel 25 is supported on bearings at the other end of the top tube 11. The down tube 9 is connected at its ends to the head tube 5 and the bottom bracket tube 7 so that it can pivot.

The bicycle 1, furthermore, has a saddle 27, which is attached to a seat post 29, which is connected to the top tube 11 so that it can pivot.

The four tubes 5, 7, 9 and 11 of the frame 3 make a four bar system, in which the distance between the connecting points 31 and 33 of the down and top tubes 9 and 11 to the head tube 5 is greater than the distance between the connecting points 35 and 37 of the top and down tubes 9 and 11 to the bottom bracket tube 7, and in which the distance between the connecting points 31 and 35 on the down tube 9 is greater than the distance between the connecting points 33 and 37 on the top tube 11.

By tilting the bottom bracket tube 7 downwards the head tube 5 is also pulled downwards as a result of which the bicycle 1 is brought from the normal position (FIG. 1) to the recumbent position (FIG. 2). Tilting the bottom bracket tube 7 downwards takes place by exerting a force, for example the user's weight, on the bicycle's saddle 27. This force is transmitted to the bottom bracket tube 7 through an auxiliary connecting bar 39, which is connected to the seat post 29 and the bottom bracket tube 7 so that it can pivot. This force causes the bottom bracket tube 7 to pivot about the connecting point 37 on the top tube 11. The bottom bracket tube 7 pushes the down tube 9 forward, as a result of which the head tube 5 also tilts to the position shown in FIG. 2.

The bicycle 1, furthermore, has a gas spring 41 with a damping effect, which is connected to the seat post 29 and the top tube 11 so that it can pivot. Because of this, the bicycle 1 will gradually be brought from the normal position (FIG. 1) to the recumbent position (FIG. 2). The position of the bicycle 1 can be secured against displacement by a blocking mechanism, which can block pivoting of the tubes 5, 7, 9 and 11 of the frame 3. The blocking mechanism is made up of the gas spring 41, which can be blocked by means of a handle on the handlebar with which the passages in the gas spring can be closed off. If the piston of the gas spring 41 is blocked with respect to the piston housing, then the seat post 29 is fixed with respect to top tube 11. Because of this, the bottom bracket tube 7 is also fixed with respect to the top tube 11, the result of which is that the down tube 9 and the head tube 5 are also fixed with respect to the top tube 11 and therefore all the tubes of the frame 3 are fixed with respect to each other.

For the bicycle 1 to run true, it is desirable that the fork 17 remains in the same place in both positions of the bicycle. For this purpose, the fork 17 is supported on bearings in an auxiliary element 43, which is connected to the head tube 5 so that it can pivot. The additional auxiliary bar 45 is connected to the down tube 9 and to the auxiliary element 43 so that it can pivot, in which the connecting point 31 of the head tube 5 to the down tube 9 is situated at a distance from the pivoting point 47 of the additional auxiliary bar 45 with the down tube 9. Furthermore, the pivoting point 49 of the head tube 5 with the auxiliary element 43 is situated at a distance from the pivoting point 51 of the additional auxiliary bar 45 with the auxiliary element 43. The additional auxiliary bar 45, the auxiliary element 43, a part of the head tube 5, and a part of the down tube 9 form a four bar system as a result of which the auxiliary element 43 remains in the same place while the position of the bicycle 1 is being changed. In order to be able to transmit the movement of the handlebar 15, the fork 17 is connected to the handlebar stem 13 by means of a universal joint.

The handlebar stem 13 has two parts that can slide with respect to each other. One part is a hollow bar that is situated so that it can rotate in the head tube 5. The other part is situated in the hollow bar and can be moved with respect to this bar, but it cannot be rotated in this hollow bar. To this end, this part is provided with a groove and the inner wall of the hollow bar is provided with a rib running lengthwise, which is situated in the groove. The hollow bar is connected to the fork 17 and the other part is attached to the handlebar 15. In the bicycle's normal position both parts are shoved together (see FIG. 1) and in the recumbent position the parts are shoved apart (see FIG. 2). Furthermore, the two parts can be fixed with respect to each other.

The bicycle 1, furthermore, has a back support 53 which can swing down. This consists of a left part and a right part, each of which can rotate between a first position in which they are situated in one plane, perpendicular to the frame 3 (see FIG. 1), and a second position in which they are parallel to each other and to the frame 3 (see FIG. 2). The parts have no function in the first position and are situated parallel to the direction of travel as a result of which they cause less air resistance. In the second position they form the back support. The parts can rotate about an axle and swing down automatically by means of a cable 55 when the position of the bicycle 1 is changed. This cable 55 is fastened at one end to the bottom bracket tube 7 and when the position of the bicycle 1 is changed, it is pulled on as a result of which the parts of the back support 53 swing down.

A chain wheel 57 is attached to the bottom bracket spindle 23, which drives the rear wheel 25 by means of a chain 59. The chain 59 runs over two diverting wheels, which are connected to the bottom bracket tube 7 so that they can revolve and are situated near the connecting point 37 of the top tube 11 to the bottom bracket tube 7. Because of this, the chain 59 will remain taut in both positions of the bicycle.

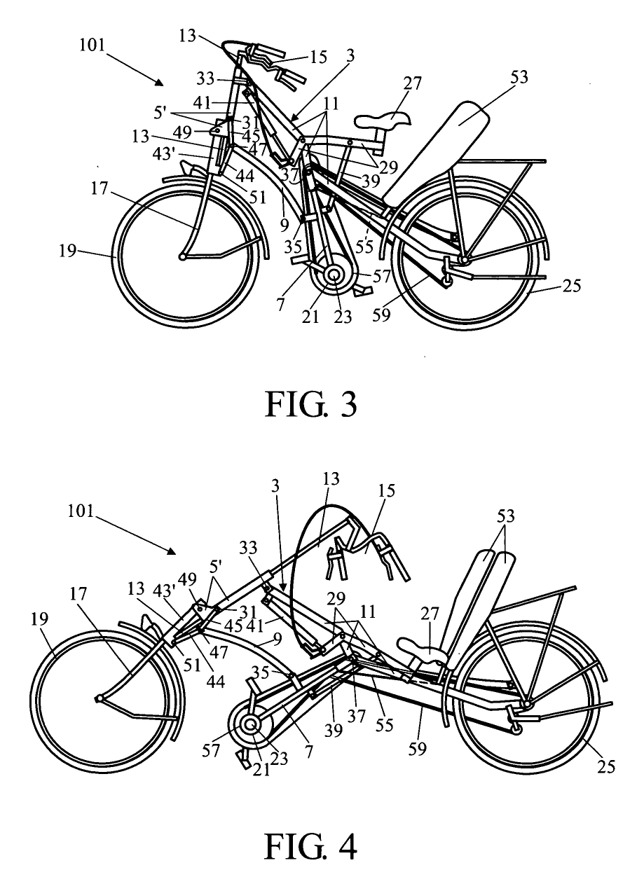

In FIGS. 3 and 4 a second embodiment of the bicycle according to the invention is shown in the normal and recumbent position respectively. All parts of the bicycle 101 according to this second embodiment that are the same as the parts of the bicycle 1 according to the first embodiment are indicated with the same reference numbers.

The construction so that the bicycle 101 will run true has been executed here a little differently. The fork 17 is supported on bearings in an auxiliary element 43′ that is connected to the head tube 5′ so that it can pivot. The auxiliary bar 44 is situated between the down tube 9 and the auxiliary element 43′ and an additional auxiliary bar 45 is situated between the down tube 9 and the head tube 5′. The auxiliary bar 44 is connected to the down tube 9 and to the auxiliary element 43′ so that it can pivot and the additional auxiliary bar 45 is connected to the down tube 9 and the head tube 5′ so that it can pivot, in which the pivoting points 31, 47 and 51 are situated at a distance from each other. The auxiliary bar 44, the additional auxiliary bar 45, the auxiliary element 43′, and the lower part of the head tube 5′ form a four bar system as a result of which the auxiliary element 43′ remains in the same place while the position of the bicycle 101 is being changed. In order to be able to transmit the movement of the handlebar 15, the fork 17 is connected to the handlebar stem 13 by means of a universal joint.

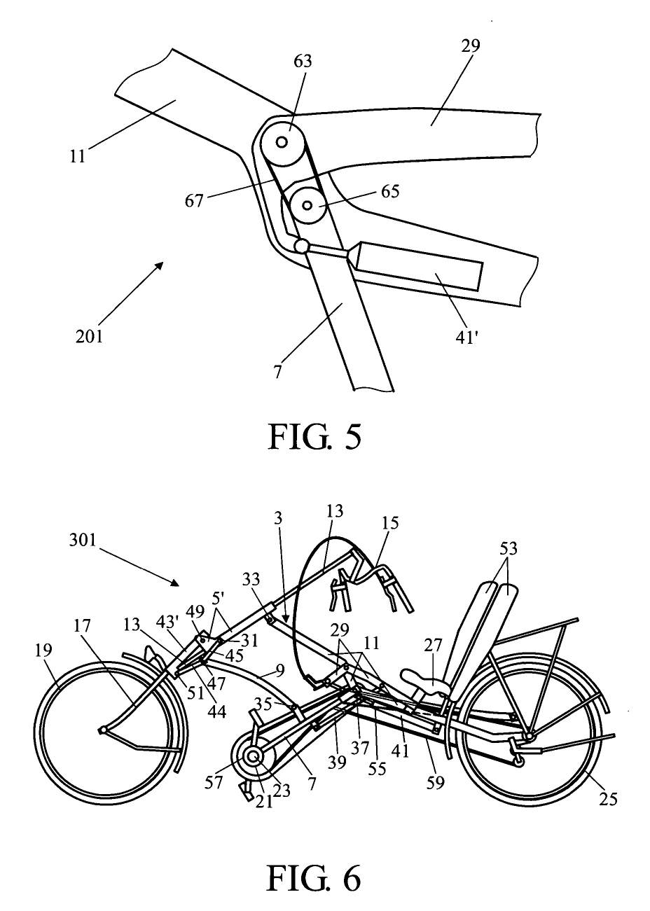

In FIG. 5 a detail of a third embodiment of the bicycle according to the invention is shown. The difference with respect to the first two embodiments is that the auxiliary connecting bar 39 here is replaced by a belt 67 that passes over two belt wheels 63, 65. One of the belt wheels 63 is attached to the seat post 29′ at the pivoting point 61 between the top tube 11 and the seat post 29′, and the other belt wheel 65 is attached to the bottom bracket tube 7 at the connecting point 37 between the top tube 11 and the bottom bracket tube 7. Furthermore, the gas spring 41′ is, in this embodiment, situated at another place.

Although in the above the invention is explained on the basis of the drawings, it should be noted that the invention is in no way limited to the embodiments shown in the drawings. The invention also extends to all embodiments deviating from the embodiments shown in the drawings within the context defined by the claims. Thus, the gas spring 41 can be situated at another place between the seat post 29 and the top tube 11, as in the fourth embodiment of the bicycle 301 according to the invention shown in FIG. 6.

1. A bicycle comprising:
a frame with a head tube;
a top tube that is connected to the head tube;
a down tube that is also connected to the head tube;
a bottom bracket tube that is connected to both the top and down tubes, in which all connecting points between the tubes are situated at a distance from each other;
a bottom bracket spindle that is connected to the bottom bracket tube, as well as a handlebar stem that can rotate in the head tube;
a handlebar that is attached to the handlebar stem;
a fork that is connected to the handlebar stem;
a front wheel that is attached to the fork so that it can revolve;
a rear wheel and a saddle that are connected to the frame, characterized in that the head tube, the bottom bracket tube, as well as the top and down tubes are connected to each other so that they can pivot.

2. The bicycle according to claim 1, characterized in that the fork is connected to the handlebar stem so that it can rotate and is supported on bearings in an auxiliary element so that it can rotate, which element is connected to the head tube so that it can pivot, and that the bicycle, furthermore, comprises an auxiliary bar, which is connected to the down tube and to the auxiliary element so that it can pivot, in which all the pivoting points between the head tube, the down tube, the auxiliary element and the auxiliary bar are situated at a distance from each other.

3. The bicycle according to claim 1, characterized in that the fork is connected to the handlebar stem so that it can rotate and is supported on bearings in an auxiliary element so that it can rotate, which element is connected to the head tube so that it can pivot, and that the bicycle, furthermore, comprises an auxiliary bar, which is connected to the down tube and to the auxiliary element so that it can pivot, as well as an additional auxiliary bar, which is connected to the down tube and to the head tube so that it can pivot, in which all pivoting points between the head tube, the down tube, the auxiliary element and the first and the additional auxiliary bar are situated at a distance from each other.

4. The bicycle according to claim 1, characterized in that the distance between the connecting points on the head tube of the top and down tubes to the head tube is greater than the distance between the connecting points of the top and down tubes to the bottom bracket tube.

5. The bicycle according to claim 1, characterized in that the distance between the connecting points on the down tube is smaller than the distance between the connecting points on the top tube.

6. The bicycle according to claim 1, characterized in that the bicycle, furthermore, comprises a seat post, to which the saddle is attached and which is connected to the top tube so that it can pivot, as well as an auxiliary connecting bar that is connected to the seat post and the bottom bracket tube so that it can pivot.

7. The bicycle according to claim 1, characterized in that the bicycle, furthermore, comprises a seat post, to which the saddle is attached and which is connected to the top tube so that it can pivot, as well as a belt or chain which passes over two belt wheels, one of which is fastened to the seat post at the pivoting point between the top tube and the seat post, and the other is fastened to the bottom bracket tube at the connecting point between the top tube and the bottom bracket tube.

8. The bicycle according to claim 1, further comprises a gas spring with a damping effect, which is connected to the seat post and the top tube so that it can pivot.

9. The bicycle according to claim 7, further comprises a gas spring with a damping effect, which is connected to the seat post and the top tube so that it can pivot.

10. The bicycle according to claim 1, further comprising an adjustable blocking mechanism, which can block the tubes of the frame from pivoting, wherein the blocking mechanism comprises a gas spring, and wherein the gas spring can be blocked.

11. The bicycle according to claim 8, further comprising an adjustable blocking mechanism, which can block the tubes of the frame from pivoting, wherein the blocking mechanism comprises the gas spring, and wherein the gas spring can be blocked.

12. The bicycle according to claim 1, characterized in that the handlebar stem comprises two parts that can slide with respect to each other, which are blocked against rotating with respect to each other, in which one part is connected to the fork so that it can rotate and the other part is attached to the handlebar.

13. The bicycle according to claim 1, further comprises a back support, which consists of a left part and a right part, which parts can rotate between a first position in which they are situated in one plane, generally perpendicular to the frame, and a second position in which they are generally parallel to each other and to the frame.
